(19) United States
(12) Patent Application Publication
(10) Pub. No.: US 2009/0049794 A1
(43) Pub. Date: Feb. 26, 2009

(54) HEAT EXCHANGER PANEL AND MANUFACTURING METHOD THEREOF USING TRANSIENT LIQUID PHASE BONDING AGENT AND VACUUM COMPRESSION BRAZING

(76) Inventors: Joseph C. Barone, Palm Beach Garden, FL (US); Ralph E. Page, Jupiter, FL (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 11/843,743

(22) Filed: Aug. 23, 2007

(51) Int. Cl. C09K 5/00

(52) U.S. Cl. 52/745.21; 52/787.11

(57) ABSTRACT

A heat exchanger panel assembly includes two panels, one with milled channels approximately in cross-section which flow coolant, and the other a close-out nominally flat panel which is bonded to the tops of the ribs of the milled channel with a thin interlayer of a transient liquid phase (TLP) bonding agent foil as the bonding interface. The method of manufacture provides transient liquid phase bonding coupled with vacuum compression. The bonding is accomplished by vacuum compression at elevated temperature in a furnace in which a vacuum is impressed on the channels while high pressure is forced on the panel exterior which forces all bonding interfaces into intimate contact.

### BACKGROUND OF THE INVENTION

The present invention relates to a method of manufacturing a heat exchanger panel, and more particularly to a method which utilizes Transient Liquid Phase bonding coupled with Vacuum Compression Brazing.

Hypersonic heat exchanger panels are high temperature heat exchangers manufactured from a nickel-based alloy. The panels typically include two components: one ribbed panel with ribs that define milled channels to flow coolant; and a close-out cover panel which is bonded to each of the ribs in the ribbed panel.

Such hypersonic panels are typically manufactured through Laser Beam Welding (LBW) to join the cover panel along the ribs. In the LBW process, each weld is directed through the solid cover panel such that each weld location requires significant precision. Also, due to the nature of the LBW weld metal profile, reduced heat is transferred through the cover panel and into the ribs such that weld continuity may be difficult to achieve. Conversely, utilization of increased LBW power may result in weld and panel distortion.

Conventional brazing has also been utilized but may obstruct the channels and block coolant flow which may produce less than optimum service performance.

Accordingly, it is desirable to provide a heat exchanger panel and manufacturing method thereof which eliminates fabrication faults, such as panel distortion, unbonded areas, and blocked cooling channels, and the requirement to locate each rib.

### SUMMARY OF THE INVENTION

The heat exchanger panel assembly according to the present invention includes a ribbed panel with channels which flow coolant, and a nominally flat cover panel which is bonded to each of the ribs defined by the channel with a thin interlayer of a transient liquid phase (TLP) bonding agent foil.

The method of manufacture according to the present invention provides transient liquid phase bonding coupled with vacuum compression brazing. The bonding is accomplished by vacuum compression at elevated temperature in a furnace in which a vacuum is formed within the channels while positive pressure is forced on the heat exchanger panel assembly exterior to force all bonding interfaces into intimate contact. When the braze temperature is reached, the TLP bonding agent melts and the melting point suppressant constituents therein diffuses into the solid base metal components (the cover panel and the ribbed panel) which then causes the remaining bonding agent to resolidify with essentially no change in temperature (isothermally). The melt-diffuse-solidify transformation takes mere seconds to occur while the parts are being compressed together by the pressure differential. The heat exchanger panel assembly is then cooled; removed from the furnace and assembly fixture; then further processed and tested such as through ultrasonic (UT) or pressure testing.

The present invention eliminates fabrication faults and the requirement to locate each rib as required for fusion welding. The present invention is also less expensive than Laser Beam Welding (LBW) and permits fabrication of multiple panels simultaneously.

The present invention therefore provides a heat exchanger panel and manufacturing method thereof, which eliminates fabrication faults, such as panel distortion, unbonded areas, and blocked cooling channels, and the requirement to locate each rib.

### BRIEF DESCRIPTION OF THE DRAWINGS

The various features and advantages of this invention will become apparent to those skilled in the art from the following detailed description of the currently disclosed embodiment. The drawings that accompany the detailed description can be briefly described as follows:

FIG. 1A is an exploded view of a heat exchanger panel assembly for use with the present invention;

FIG. 1B is an exploded view of a honeycomb core panel assembly for use with the present invention;

FIG. 2 is a top view of a ribbed panel assembly illustrating a multiple of channels with a multiple of intermediate ribs, the ribbed panel assembly tack welded to a fixture;

FIG. 3 is a block diagram flow chart illustrating the steps in a method of assembly according to the present invention;

FIG. 4 is a perspective view illustrating a ribbed panel clamped to a fixture prior to tack welding;

FIG. 5 is a perspective view of a ribbed panel having tubes welded thereto so as to provide communication with the heat exchanger assembly interior;

FIG. 6 is an exploded view illustrating a cover plate having TLP braze foil prior to tack welding therebetween;

FIG. 7 is an exploded view illustrating the cover plate having the TLP braze foil attached thereto prior to assembly with the ribbed panel as attached to the fixture;

FIG. 8 is an expanded perspective view of the weld perimeter between the cover panel and the ribbed panel thereby forming a panel assembly with the TLP braze foil sandwiched therein;

FIG. 9 is a schematic view of the panel assembly mounted to the fixture and located within a VCB furnace;

FIG. 10A is a lateral section view through a heat exchanger assembly illustrating the TLP braze foil interface between the cover plate and the ribbed plate; and

FIG. 10B is an expanded view of a single rib illustrating the bond between the rib and the cover panel provided by the braze metal and the formation of fillets therefrom.

### DETAILED DESCRIPTION OF THE DISCLOSED EMBODIMENT

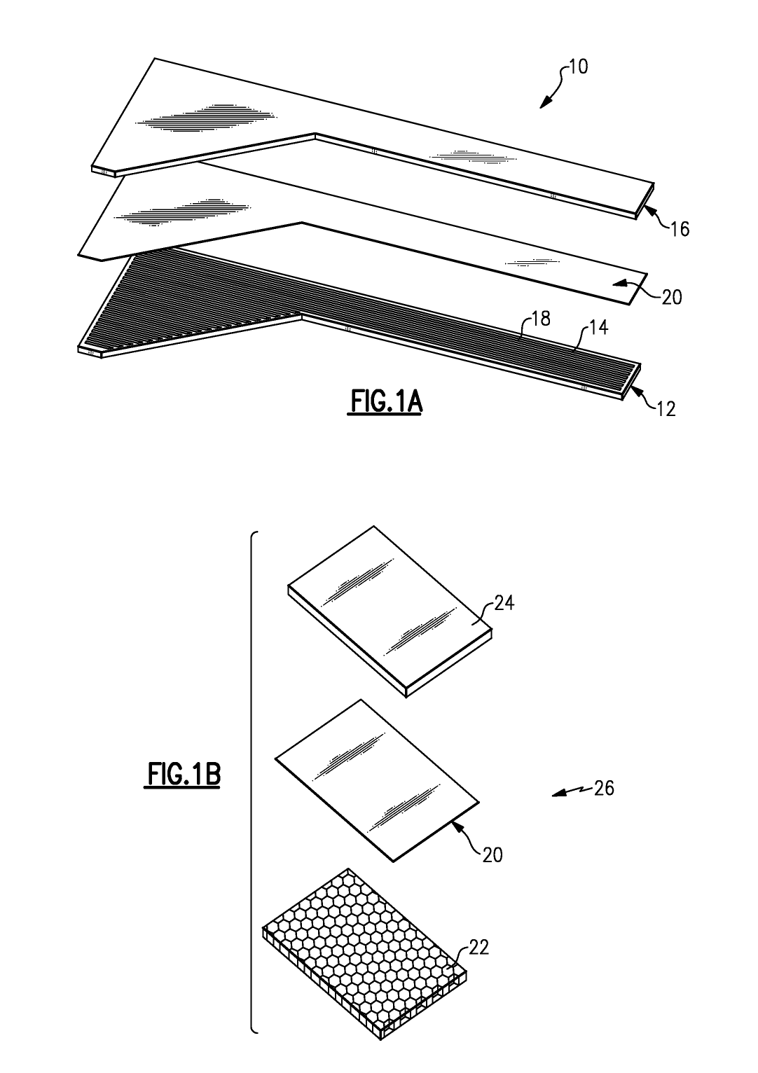

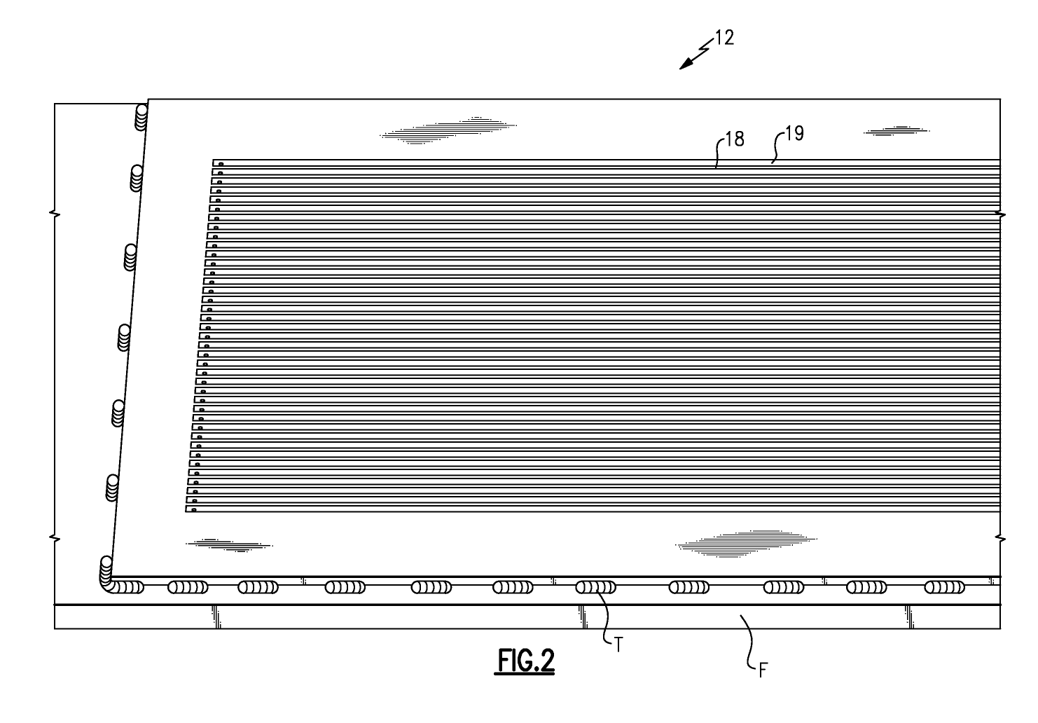

FIG. 1A schematically illustrates a panel assembly 10. The panel assembly 10 may be a hypersonic heat exchanger panel assembly. The assembly 10 generally includes one ribbed panel 12 with coolant flow path channels 14 which flow a coolant medium and a close-out cover panel 16. The close-out cover panel 16 is bonded to the ribbed panel 12 along a mating surface defined by each of a multiple of ribs 18 defined intermediate each coolant flow path channel 14 in the ribbed panel 12 (also illustrated in FIG. 2). The ribbed panel 12 and cover panel 16 may be manufactured from AMS 5599 (Inco 625) sheet and plate material. It should be understood that although the cover panel 16 is illustrated as a nominally flat panel in the illustrated embodiment, two ribbed panels may alternatively be utilized as well as various designs of heat exchanger panels, which define one, or more channels to receive a medium conducted therethrough. Such heat exchanger panels are often utilized as panel stacks for compact heat exchangers or as large-area single panels.

The cover panel 16 is bonded to the tops of the ribs 18 of the coolant flow path channels 14 with a thin interlayer of a transient liquid phase (TLP) bonding agent foil 20. The TLP bonding agent foil 20 operates as the bonding interface with a transient liquid phase bond coupled with vacuum compression brazing (TLP/VCB), which is further described below. The foil 20 may be 1.5 mil thick high temperature nickel base alloy, in the category of boron, or other melting point suppressant, containing Transient Liquid Phase (TLP) materials.

Other panel assemblies which require a bond between a porous panel 22 and a cover panel 24 such as a honeycomb core assembly 26 (FIG. 1B) may also be manufactured in accords with the disclosed method. That is, the honeycombs themselves form ribs which are bonded to the cover panel 24.

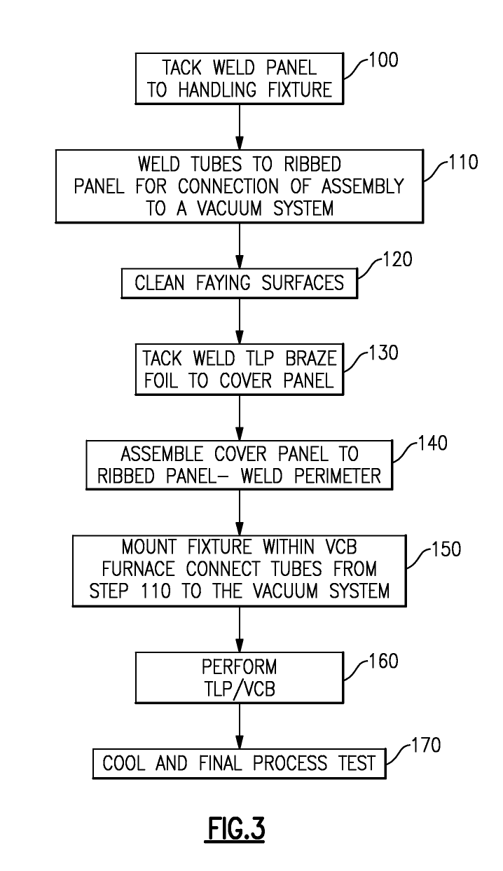

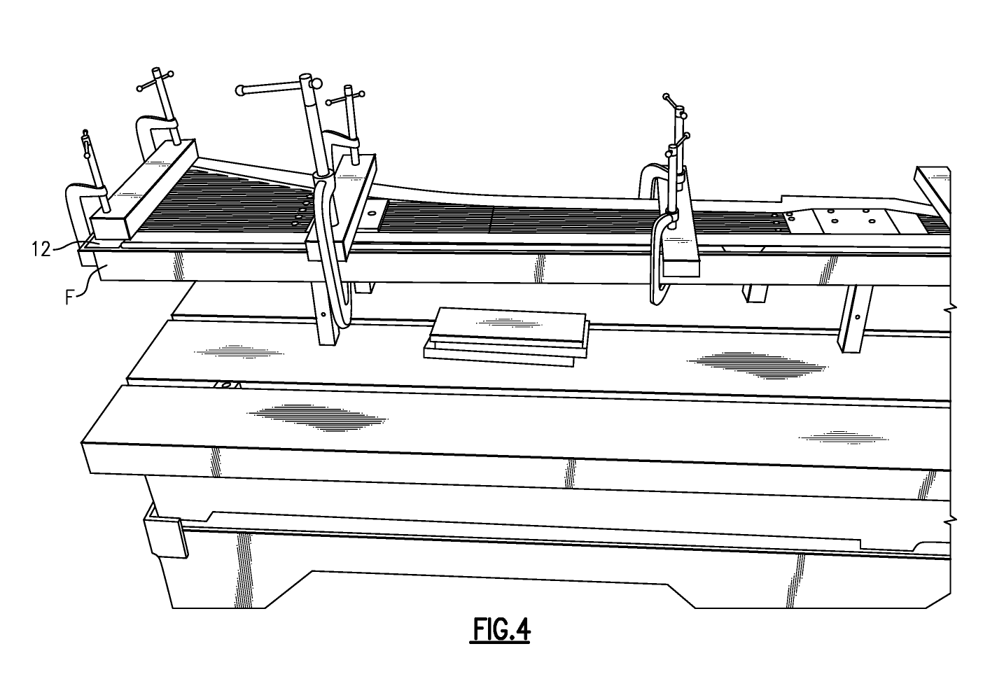

Referring to FIG. 3, a method of manufacture, which provides TLP/VC, is illustrated as a flowchart.

In step 100, the ribbed panel 12 is securely tack welded to a handling fixture F to ensure it is held in a desired shape throughout the brazing. The tack welds W may be stagger tacks to minimize distortion (FIGS. 2 and 4).

In step 110, tubes T are welded to the ribbed panel 12 to permit a vacuum to be drawn within the assembly 10 as part of the VCB process (step 160). The tubes T may be mounted through a bottom surface of the ribbed panel 12 and arranged to pass through the fixture F to provide support therefore. Tubes T connect to the coolant flow path channels 14.

In step 120, the ribbed panel 12 and the cover panel 16 faying surfaces (surfaces to be bonded) are cleaned and deburred. This also serves to remove any oxide layer and leaves clean, smooth (but not polished) surface for the TLP braze foil 20 to wet. Further cleaning may also be performed as cleanliness is important to most any brazing process.

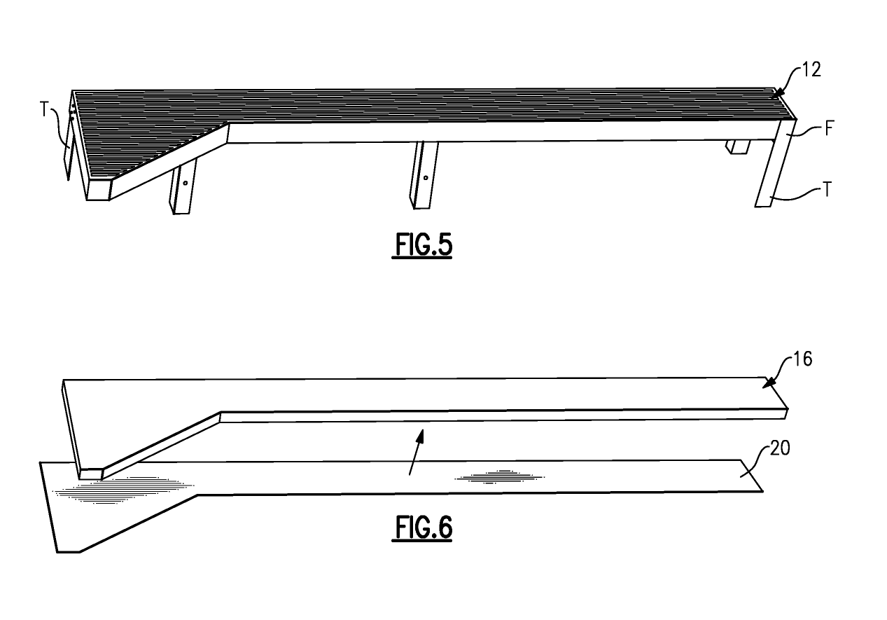

In step 130, the TLP braze foil 20 is resistance tack welded onto the cover panel 16 in a clean environment (FIG. 6). The foil 20 is positioned so that the longer dimension of the foil 20 sections (strips) will be perpendicular to the ribs 18 after final assembly. The foil 20 sections are placed side-by-side with no gaps or overlaps. The TLP braze foil 20 may be poke tack welded in a multiple of locations working from one side to the other so as to eliminate wrinkles.

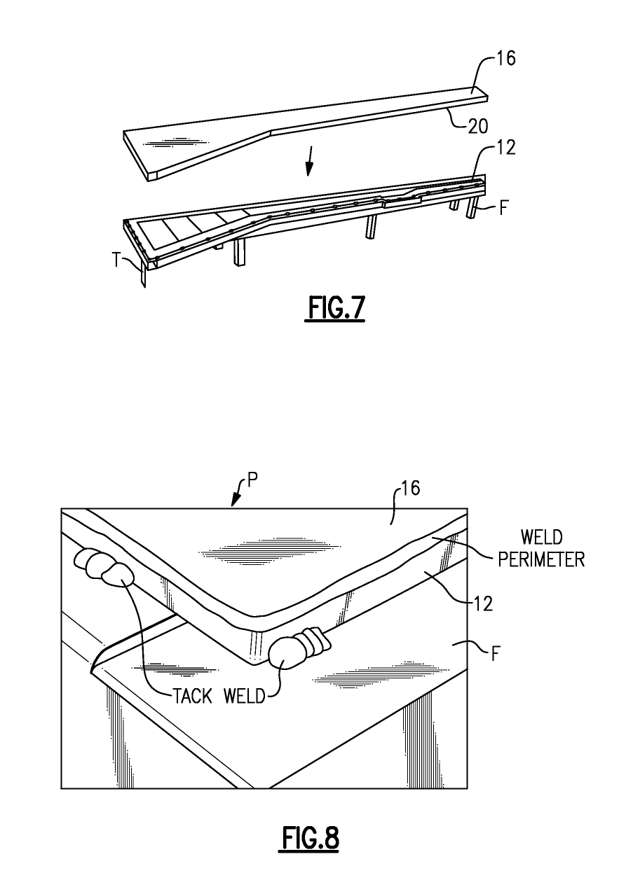

In step 140, the cover panel 16 is then assembled to the ribbed panel 12 with the TLP braze foil 20 therebetween (FIG. 7) to form a panel assembly P. The cover panel 16 is welded around the perimeter to seal the panel assembly P (FIG. 8). The welds may be fusion welds or other such welds which seal the panel assembly P. Nickel-plated copper chill bars may also be utilized while an inert gas such as Argon is flowed through the cooling flow path channels 14.

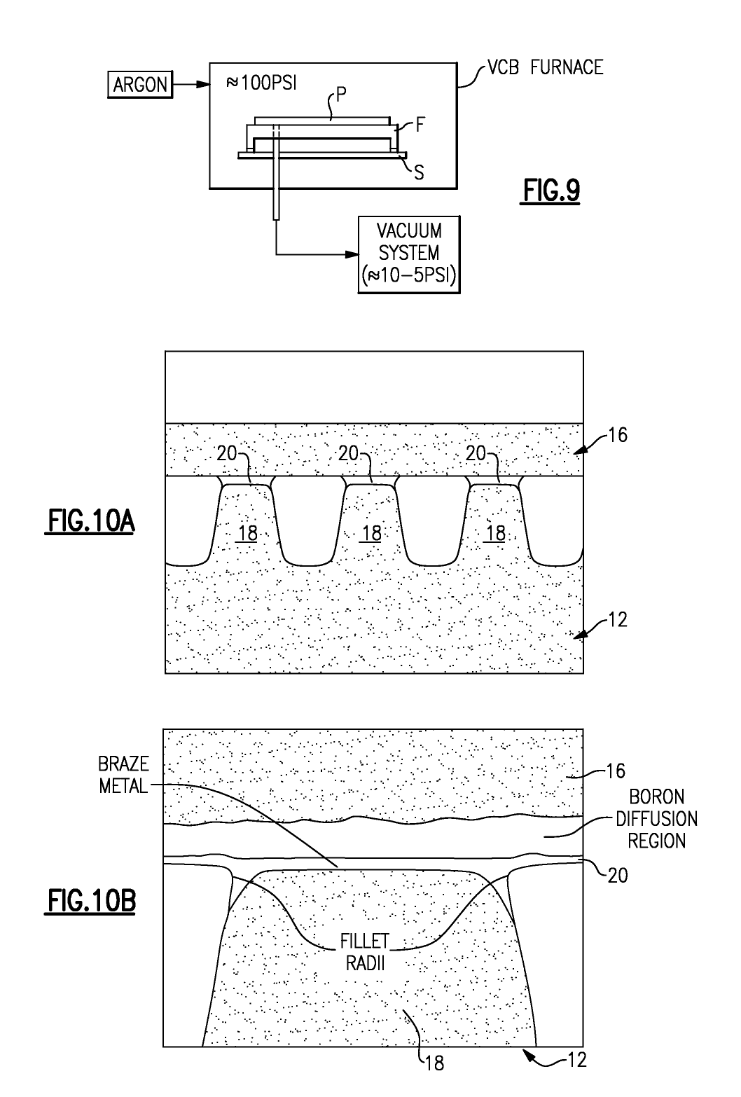

In step 150, the fixture F is mounted in a vacuum compression braze (VCB) furnace on a rotation spindle S and the tubes T are connected to a vacuum system (FIG. 9). The VCB furnace may be of the type manufactured by ABAR-IPSEN International Inc. of Connecticut, USA.

In step 160, air is evacuated from both the VCB vacuum compression furnace chamber and the panel assembly P prior to the braze cycle. Then, before or during the braze cycle, Argon is added to the VCB furnace to provide a uniform pressure differential between the inside and outside of the panel assembly P which causes the ribbed panel 12 and cover panel 16 to remain in uniform contact as the braze melts. A high pressure atmosphere of approximately 100 psi within the VCB furnace is applied to the external panel surfaces to place the bond joints in compression while a vacuum of approximately 10-40 microns is provided within the panel assembly P.

To regulate the pressure differential between the panel assembly P and the VCB furnace chamber, the inside of the panel assembly P is held under a constant vacuum while the VCB furnace chamber is evacuated to remove air and then pressurized to some pressure above atmospheric with the argon. This pressurization is performed early in the braze cycle either before heat is applied or before it reaches a certain temperature below the braze temp. The pressurized Argon which surrounds the outside of the panel assembly P along with the vacuum inside the panel assembly P provides the uniform compression.

When the braze temperature is reached, the TLP braze foil 20 melts and the boron, or other melting point suppressant, therein diffuses from the melted TLP braze foil 20 into the solid base metal of the ribbed panel 12 and the cover panel 16 which then causes the remaining braze material to resolidify with essentially no change in temperature (isothermally). The melt-diffuse-solidify transformation takes mere seconds to occur, while the ribbed panel 12 and the cover panel 16 are compressed together by the pressure differential. The TLP braze foil that was between the ribs wets the surface of the cover panel, and the sides of the ribs to generate a corner fillet between the two (FIGS. 10A and 10B)

In step 170, the heat exchanger assembly 10 is then cooled, removed from the furnace and fixture, then further processed or tested such as by ultrasonic (UT) or pressure testing.

It should be understood that relative positional terms such as “forward,” “aft,” “upper,” “lower,” “above,” “below,” and the like are with reference to the normal operational attitude of the vehicle and should not be considered otherwise limiting.

It should be understood that although a particular component arrangement is disclosed in the illustrated embodiment, other arrangements will benefit from the instant invention.

Although particular step sequences are shown, described, and claimed, it should be understood that steps may be performed in any order, separated or combined unless otherwise indicated and will still benefit from the present invention.

The foregoing description is exemplary rather than defined by the limitations within. Many modifications and variations of the present invention are possible in light of the above teachings. The disclosed embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A panel assembly comprising:
a first panel with at least one rib;
a second panel; and
a braze along an inner surface of said second panel to attach said rib to said second panel and at least partially forms a corner fillet between said at least one rib and said second panel.

2. The assembly as recited in claim 1, wherein said braze is formed from a transient liquid phase (TLP) bonding agent foil.

3. The assembly as recited in claim 1, wherein said panel assembly forms a heat exchanger.

4. The assembly as recited in claim 1, wherein said panel assembly forms a honeycomb core assembly panel.

5. A method of manufacturing a panel assembly comprising the steps of:
(A) mounting a first panel to a frame;
(B) tacking a TLP braze foil onto a second panel;
(C) assembling the second panel to the first panel with the TLP braze foil therebetween to form a panel assembly; and
(D) generating a melt-diffuse-solidify transformation while the first panel and the second panel are compressed together by a uniform pressure differential to braze the first panel to the second panel.

6. A method as recited in claim 5, wherein said step (A) further comprises:
(a) attaching the first panel to the frame through tack welding.

7. A method as recited in claim 5, wherein said step (D) further comprises:
(a) generating the pressure differential with a high pressure atmosphere of approximately 100 psi around the panel assembly and a vacuum of approximately 10-40 microns within the panel assembly.

8. A method as recited in claim 5, wherein said step (D) further comprises:
(a) mounting the panel assembly within a VCB vacuum compression furnace.

9. A method as recited in claim 8, wherein said step (a) further comprises:
(i) welding tubes which communicate with the interior of the panel assembly to a vacuum system.

10. A method as recited in claim 8, wherein said step (a) further comprises:
(i) communicating an inert gas within the VCB vacuum compression furnace chamber to provide the uniform pressure differential between the interior and exterior of the panel assembly.

11. A method as recited in claim 5, wherein said step (A) further comprises:
(a) providing a ribbed panel as the first panel, the ribbed panel having at least one channel.

12. A method as recited in claim 11, wherein said step (B) further comprises:
(a) providing a planar cover panel as the second panel.

13. A method as recited in claim 5, wherein said step (A) further comprises:
(a) providing a honeycomb panel as the first panel.

14. A method of manufacturing a heat exchanger panel assembly comprising the steps of:
(A) mounting a ribbed panel with at least one rib to a frame;
(B) tacking a TLP braze foil onto a cover panel;
(C) assembling the cover panel to the ribbed pane with the TLP braze foil therebetween to form a panel assembly; and
(D) compressing the panel assembly together with a uniform pressure differential to braze an inner surface of the cover panel to the at least one rib to form a braze between the at least one rib and the cover panel, the braze forming a corner fillet between the at least one rib and the cover panel.

15. A method as recited in claim 14, wherein said step (D) further comprises:
(a) generating the pressure differential with a high pressure atmosphere of approximately 100 psi around the panel assembly and a vacuum of approximately 10-40 microns within the panel assembly.

16. A method as recited in claim 14, wherein said step (D) further comprises:
(a) mounting the panel assembly within a VCB vacuum compression furnace.
